(19) United States
(12) Patent Application Publication
(10) Pub. No.: US 2009/0065358 A1
(43) Pub. Date: Mar. 12, 2009

(54) OXYGEN SENSOR, AND INTERNAL COMBUSTION ENGINE AND TRANSPORT APPARATUS PROVIDED WITH THE OXYGEN SENSOR

(75) Inventor: Hiroshi Matsumoto, Shizuoka (JP)

Correspondence Address: YAMAHA HATSUDOKI KABUSHIKI KAISHA;C/O KEATING & BENNETT, LLP, 1800 Alexander Bell Drive, SUITE 200, Reston, VA, 20191, US

(73) Assignee: YAMAHA HATSUDOKI KABUSHIKI KAISHA, Iwata-shi, Shizuoka-ken (JP)

(21) Appl. No.: 12/299,513

(22) PCT Filed: Dec. 4, 2007
(86) PCT No.: PCT/JP2007/073372

§ 371 Date: Nov. 25, 2008

(30) Foreign Application Priority Data
Dec. 20, 2006 (JP) 2006-342198

(51) Int. Cl. G01N 27/26

(52) U.S. Cl. 204/424

(57) ABSTRACT

An oxygen sensor which is highly waterproof in a high-temperature environment and yet allows for downsizing includes a sensor element having a detection section arranged to detect oxygen, a housing, the sensor element being inserted at one end thereof in such a manner that the detection section is exposed, a cylindrical member provided at another end of the housing, a sealing member arranged to seal the cylindrical member, and a terminal portion connected to the sensor element. The sealing member has a throughhole, and is made of a heat-resistant resin. The terminal portion is press-fitted in the throughhole of the sealing member.

### BACKGROUND OF THE INVENTION

1. Field of the Invention

The present invention relates to an oxygen sensor. Moreover, the present invention relates to an internal combustion engine and a transportation apparatus incorporating an oxygen sensor.

2. Description of the Related Art

From the standpoint of environmental issues and energy issues, it has been desired to improve the fuel consumption of internal combustion engines, and reduce the emission amount of regulated substances (e.g., NOx) that are contained within exhaust gas emitted from internal combustion engines. In order to meet these needs, it is necessary to appropriately control the ratio between fuel and air in accordance with the state of combustion, so that fuel combustion will occur always under optimum conditions. The ratio of air to fuel is called an air-fuel ratio (A/F). In the case where a ternary catalyst is employed, the optimum air-fuel ratio would be the stoichiometric air-fuel ratio. The stoichiometric air-fuel ratio is an air-fuel ratio at which air and fuel will just sufficiently combust.

When fuel is combusting at the stoichiometric air-fuel ratio, a certain amount of oxygen is contained within the exhaust gas. When the air-fuel ratio is smaller than the stoichiometric air-fuel ratio (i.e., the fuel concentration is relatively high), the oxygen amount in the exhaust gas decreases relative to that under the stoichiometric air-fuel ratio. On the other hand, when the air-fuel ratio is greater than the stoichiometric air-fuel ratio (i.e., the fuel concentration is relatively low), the oxygen amount in the exhaust gas increases. Therefore, by measuring the oxygen amount or oxygen concentration in the exhaust gas by using a sensor, it is possible to estimate how much deviation the air-fuel ratio has relative to the stoichiometric air-fuel ratio. This makes it possible to adjust the air-fuel ratio and control the fuel combustion so as to occur under the optimum conditions.

An oxygen sensor for detecting oxygen within exhaust gas is to be attached to an exhaust pipe of an internal combustion engine, and therefore may possibly be wetted during travel. Therefore, an oxygen sensor is preferably structured so that intrusion of water into the interior is prevented. An oxygen sensor having such a highly-waterproof structure is disclosed in Japanese Patent No. 3493875.

FIG. 16 shows an oxygen sensor 800 with a waterproof structure which is disclosed in Japanese Patent No. 3493875. The oxygen sensor 800 includes a sensor element 810 and a housing 820 into which the sensor element 810 is inserted. The housing 820 is made of a metal material such as stainless steel. The housing 820 allows the oxygen sensor 800 to be secured to an exhaust pipe of an internal combustion engine.

The sensor element 810 includes a detection section 811 for detecting oxygen and a substrate 812 for supporting the detection section 811. The sensor element 810 is disposed at the lower end of the housing 820 in such a manner that the detection section 811 is exposed. The sensor element 810 is secured to the housing 820 by an attachment member 821 which is formed inside the housing 820 from a glass material.

At the lower end of the housing 820, a cover member 870 is provided so as to cover the detection section 811 of the sensor element 810. The cover member 870 is composed of an inner cover 871 and an outer cover 872. An opening 873 for allowing exhaust gas in is formed in each of the inner cover 871 and the outer cover 872.

The sensor element 810 is electrically connected to leads 860 via a terminal portion 850 which is provided at an end thereof. The leads 860 are coated with an insulative resin (e.g. PTFE).

At the upper end of the housing 820, a cylindrical member 830 which is made of a metal material such as stainless steel is provided. Inside the cylindrical member 830 is disposed a rubber member 840 having throughholes 842 in which the leads 860 are to be inserted. By crimping inward a portion 831 of the cylindrical member 830 (i.e., a portion where the rubber member 840 is disposed), the leads 860 become secured and the cylindrical member 830 becomes sealed.

However, even if a structure as shown in Japanese Patent No. 3493875 is used, the area around the exhaust pipe reaches a high temperature, thus leading to the following problems. As a result, it is actually impossible to attain a sufficient waterproofness.

First, the rubber member 840 has poor heat resistance. For example, a rubber member 840 which is made of fluoro rubber has a withstand temperature of about 200° C. Therefore, the rubber member 840 is deteriorated due to heat from the exhaust pipe, which is conducted via the cylindrical member 830 made of a metal material, thus resulting in a lower waterproofness. Although it might be possible to lengthen the cylindrical member 830 in order to suppress a temperature increase of the rubber member 840, such a construction would make the oxygen sensor 800 itself long, thus requiring a large space for accommodation. Moreover, the resin with which the leads 860 are coated will shrink while being exposed to a high-temperature atmosphere for a long time, thus creating a gap between the leads 860 and the rubber member 840. This also lowers waterproofness.

### SUMMARY OF THE INVENTION

In view of the aforementioned problems, preferred embodiments of the present invention provide an oxygen sensor which is highly waterproof in a high-temperature environment and yet allows for downsizing.

An oxygen sensor according to a preferred embodiment of the present invention includes a sensor element having a detection section arranged to detect oxygen, a housing, the sensor element being inserted at one end thereof in such a manner that the detection section is exposed, a cylindrical member provided at another end of the housing, a sealing member arranged to seal the cylindrical member, and a terminal portion connected to the sensor element, wherein, the sealing member has a throughhole, and is made of a heat-resistant resin, and the terminal portion is press-fitted in the throughhole of the sealing member.

In a preferred embodiment, the housing and the sealing member abut each other.

In a preferred embodiment, the housing and the sealing member are shaped so as to be fitted together.

In a preferred embodiment, the heat-resistant resin has a glass transition temperature or heat deflection temperature of about 250° C. or more, for example.

In a preferred embodiment, the oxygen sensor according to the present invention includes a lead which is electrically connected to the sensor element via the terminal portion, wherein, the lead is inserted in the throughhole of the sealing member.

In a preferred embodiment, the oxygen sensor according to the present invention further includes a watertight cap covering the lead, wherein the lead is inserted in the throughhole together with the watertight cap.

An internal combustion engine according to another preferred embodiment of the present invention includes an oxygen sensor having the above construction.

A transportation apparatus according to a further preferred embodiment of the present invention includes an internal combustion engine having the above construction.

In an oxygen sensor according to a preferred embodiment of the present invention, the terminal portion is press-fitted in a throughhole of the sealing member, thus sealing the cylindrical member and forming a watertight structure. Therefore, the sealing member does not need to be a rubber member, and a heat-resistant resin can be used as the material of the sealing member. As a result, it is possible to suppress deterioration in waterproofness due to deterioration of the sealing member itself due to heat. Moreover, since it is unnecessary to make the cylindrical member long in order to prevent deterioration of the sealing member due to heat, the oxygen sensor itself can be downsized. Furthermore, since the throughhole of the sealing member is closed by the press-fitted terminal portion, even if a resin with which the lead is coated shrinks due to heat, intrusion of water inside the oxygen sensor can be prevented.

By adopting a construction in which the housing and the sealing member abut each other, the housing and the sealing member can be allowed to function as a positioning structure during the production steps of the oxygen sensor, thus resulting in a greater ease of assembly.

In the case where the housing and the sealing member are shaped so as to be fitted together, movement of the sealing member along the horizontal direction (the direction orthogonal to the center axis of the oxygen sensor) can be limited when press-fitting the sealing member to the cylindrical member. Therefore, the stress acting on the foot of the sensor element can be reduced, and occurrence of product defects due to breakage of the sensor element can be prevented and minimized.

From the standpoint of preventing deterioration of the sealing member due to heat, it is preferable that the heat-resistant resin which is the material of the sealing member has a glass transition temperature or heat deflection temperature of about 250° C. or more, for example.

An oxygen sensor according to a preferred embodiment of the present invention typically has a lead which is electrically connected to the sensor element via the terminal portion, this lead being inserted in the throughhole of the sealing member.

By providing a watertight cap so as to cover the lead, and inserting the lead into the throughhole of the sealing member together with the watertight cap, intrusion of water and dust inside the oxygen sensor can be prevented with greater certainty.

An oxygen sensor according to a preferred embodiment of the present invention is highly waterproof in a high-temperature environment, and therefore is suitably used for the detection of oxygen within the exhaust gas which is emitted from an internal combustion engine. An oxygen sensor according to a preferred embodiment of the present invention can be downsized (having good space economy), and therefore the space required for attachment to an exhaust pipe can be reduced. Therefore, the entire internal combustion engine can be downsized.

An internal combustion engine having the oxygen sensor according to a preferred embodiment of the present invention is suitably used for various transportation apparatuses such as motorcycles.

According to a preferred embodiment of the present invention, there is provided an oxygen sensor which is highly waterproof in a high-temperature environment and yet allows for downsizing (i.e., having good space economy).

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a cross-sectional view schematically showing an oxygen sensor according to a preferred embodiment of the present invention.

FIG. 2 is a perspective view schematically showing a cylindrical member of the oxygen sensor according to a preferred embodiment of the present invention.

FIG. 3 is a perspective view schematically showing a sealing member of the oxygen sensor according to a preferred embodiment of the present invention.

FIG. 4 is a perspective view schematically showing a watertight cap of the oxygen sensor according to a preferred embodiment of the present invention.

FIGS. 5A, 5B and 5C are perspective views schematically showing a first terminal, a second terminal, and a third terminal of the oxygen sensor according to a preferred embodiment of the present invention.

FIG. 6 is a perspective view schematically showing a terminal portion of the oxygen sensor according to a preferred embodiment of the present invention.

FIGS. 7A-7F are step-by-step cross-sectional views schematically showing production steps for the oxygen sensor according to a preferred embodiment of the present invention.

FIGS. 8A-8E are step-by-step cross-sectional views schematically showing production steps for the oxygen sensor according to a preferred embodiment of the present invention.

FIG. 9 is a cross-sectional view schematically showing another oxygen sensor according to another preferred embodiment of the present invention.

FIGS. 10A-10D are step-by-step cross-sectional views schematically showing production steps for the oxygen sensor according to another preferred embodiment of the present invention.

FIG. 11 is a cross-sectional view schematically showing still another oxygen sensor according to yet another preferred embodiment of the present invention.

FIGS. 12A-12D are step-by-step cross-sectional views schematically showing production steps for the oxygen sensor shown in FIG. 11.

FIG. 13 is a diagram for explaining a test method for an airtightness test.

FIG. 14 is a side view schematically showing a motorcycle incorporating the oxygen sensor according to a preferred embodiment of the present invention.

FIG. 15 is a diagram schematically showing a control system of an internal combustion engine in a motorcycle.

FIG. 16 is a cross-sectional view schematically showing a conventional oxygen sensor.

### DETAILED DESCRIPTION OF THE PREFERRED EMBODIMENTS

Hereinafter, preferred embodiments of the present invention will be described with reference to the drawings. Note that the present invention is not limited to the following preferred embodiments.

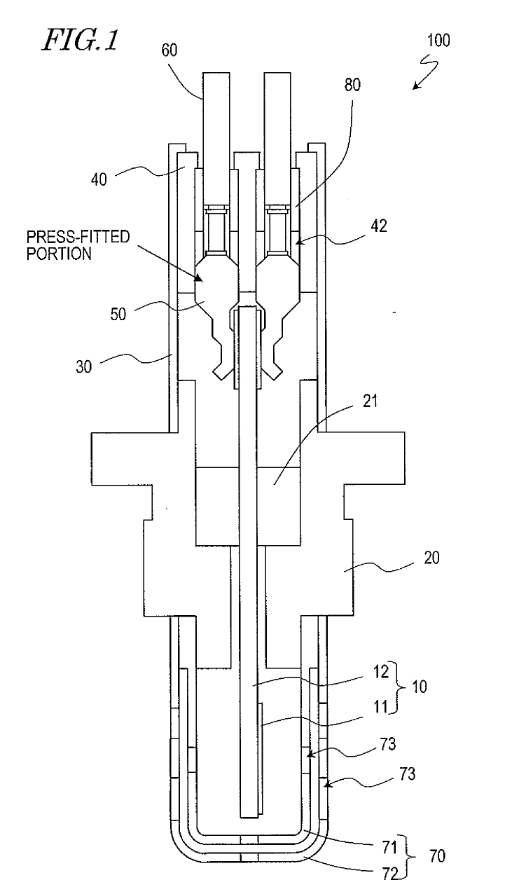

FIG. 1 shows an oxygen sensor 100 according to the present preferred embodiment. As shown in FIG. 1, the oxygen sensor 100 includes a sensor element 10 and a housing 20 into which the sensor element 10 is inserted. The housing 20 is preferably made of a metal material such as stainless steel. The housing 20 allows the oxygen sensor 100 to be secured to an exhaust pipe of an internal combustion engine.

The sensor element 10 includes a detection section 11 arranged to detect oxygen and a substrate 12 arranged to support the detection section 11. The sensor element 10 is disposed at one end of the housing 20 in such a manner that the detection section 11 is exposed. In the present preferred embodiment, the sensor element 10 is secured to the housing 20 by an attachment member (made of, e.g., a glass material) 21 which is disposed inside the housing 20. Note, however, that the structure for securing the sensor element 10 to the housing 20 is not limited thereto.

As the sensor element 10, various devices can be used that are capable of detecting oxygen. For example, a sensor element of an electromotive force type using a solid electrolyte as disclosed in Japanese Laid-Open Patent Publication No. 8-114571, or a sensor element of a resistance type as disclosed in Japanese Laid-Open Patent Publication No. 5-18921 can be used.

A sensor element of the electromotive force type measures an oxygen concentration by detecting, as an electromotive force, a difference in oxygen partial pressure between a reference electrode which is exposed to the air and a measuring electrode which is exposed to exhaust gas. On the other hand, a sensor element of a resistance type detects changes in the resistivity of an oxide semiconductor layer which is provided so as to be in contact with the exhaust gas. When the oxygen partial pressure within the exhaust gas changes, the oxygen vacancy concentration in the oxide semiconductor layer changes, whereby the resistivity of the oxide semiconductor layer changes. Therefore, by detecting such changes in resistivity, it is possible to measure the oxygen concentration.

Unlike a sensor element of the electromotive force type, a sensor element of the resistance type does not require a reference electrode, and therefore permits the structure of the sensor element itself to be simplified. Therefore, from the standpoint of downsizing the oxygen sensor 100, it is preferable to use a sensor element of the resistance type. As an oxide semiconductor for a sensor element of the resistance type, titania (titanium dioxide) is used, for example. Alternatively, cerium oxide may be used. Cerium oxide has good durability and stability.

In the case where the sensor element 10 is of the electromotive force type, the detection section 11 includes a solid electrolyte layer and electrodes. In the case where the sensor element 10 is of the resistance type, the detection section 11 includes an oxide semiconductor layer and electrodes. The substrate 12 of the sensor element 10 is made of an insulative material (e.g., a ceramic material such as alumina or silicon nitride), and the detection section 11 is provided at an end of the substrate 12.

At an end of the housing 20, a cover member 70 is arranged so as to cover the detection section 11 of the sensor element 10. The cover member 70 preferably includes an inner cover 71 and an outer cover 72. An opening 73 for allowing exhaust gas in is formed in each of the inner cover 71 and the outer cover 72. Preferably, the opening 73 of the inner cover 71 and the opening 73 of the outer cover 72 are disposed so as not to overlap each other, so that the exhaust gas flowing within the exhaust pipe does not directly hit the detection section 11. The inner cover 71 and the outer cover 72 are preferably made of a metal material such as stainless steel, and is bonded to the housing 20 by welding, for example. The inner cover 71 and the outer cover 72 are cylindrical, for example.

The oxygen sensor 100 of the present preferred embodiment further includes a cylindrical member 30 provided at another end of the housing 20 (the opposite end from where the detection section 11 of the sensor element 10 is exposed), a sealing member 40 which seals the cylindrical member 30, terminal portions 50 connected to the sensor element 10, and leads 60 which are electrically connected to the sensor element 10 via the terminal portions 50.

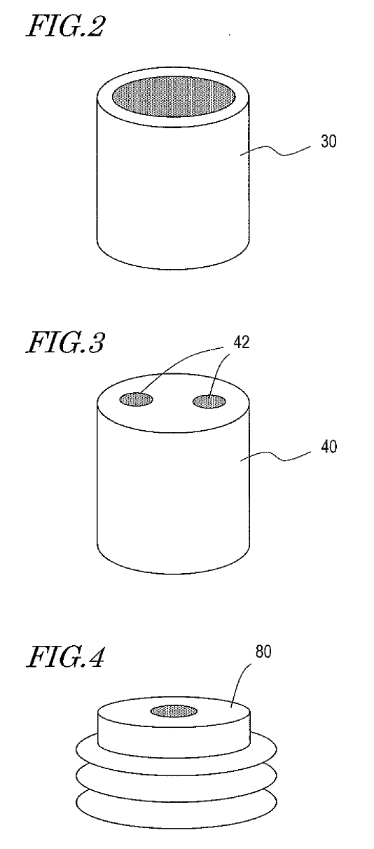

The cylindrical member 30 is made of a metal material such as stainless steel (e.g., SUS304), and is cylindrical as shown in FIG. 2. It is preferable that the thickness of the cylindrical member 30 is about 0.7 mm or less, for example. By forming a cylindrical member 30 which is so thin as about 0.7 mm or less, it becomes possible to reduce propagation of heat from the exhaust pipe toward the sealing member 40. This also makes it easy for the cylindrical member 30 to be deformed when the sealing member 40 is pressed into the cylindrical member 30, with the terminal portions 50 having been pressed into the sealing member 40, as described later. As a result, press-in can be suitably performed. The sealing member 40 is provided at the farther end of the cylindrical member 30 from the housing 20. In the cylindrical member 30 of the present preferred embodiment, it is unnecessary to provide the crimped portion 831, which is provided in the cylindrical member 830 of Japanese Patent No. 3493875. Therefore, as shown in FIG. 1, the inner diameter of the cylindrical member 30 can be made substantially identical along the longitudinal direction (i.e., a cylindrical member 30 having no constricted portion can be used). It will be appreciated that, as shown in drawings described later, the inner diameter of the cylindrical member 30 may change along the longitudinal direction.

As shown in FIG. 1 and FIG. 3, the sealing member 40 includes columnar throughholes 42 into which the leads 60 and the terminal portions 50 are inserted. Although FIG. 3 illustrates the sealing member 40 as having two throughholes 42, the number of throughholes 42 is not limited to two. The sealing member 40 in the present preferred embodiment is preferably made of a heat-resistant resin. As the heat-resistant resin, polyimide resin or phenolic resin may be used, for example.

The leads 60 are made of a metal material (e.g. copper), and is coated with an insulation material (a resin such as PTFE). In the present preferred embodiment, the leads 60 are further covered by a watertight cap 80 in the shape of bellows as shown in FIG. 4, and together with the watertight cap 80, inserted into the throughholes 42. The watertight cap 80 is made of fluoro rubber, silicone rubber, or the like.

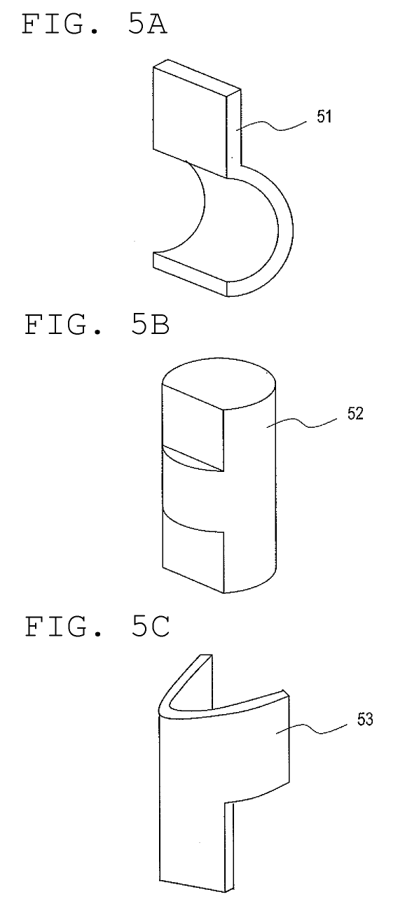

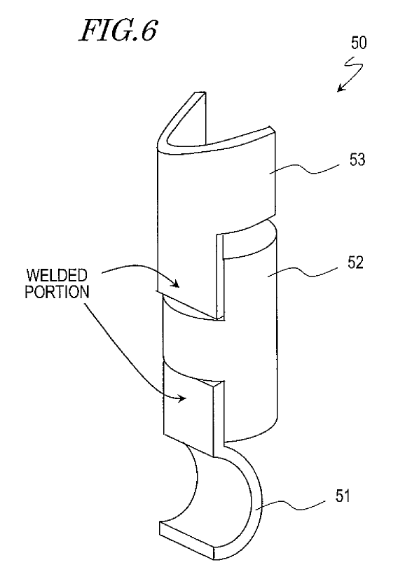

The terminal portions 50 are made of a metal material such as stainless steel or nickel alloy, and electrically connect the sensor element 10 and the leads 60. In the present preferred embodiment, the terminal portions 50 are press-fitted in the throughholes 42 of the sealing member 40, as also shown in FIG. 1. The more detailed structure of the terminal portions 50 will be described with reference to FIGS. 5A-5C and FIG. 6.

Each terminal portion 50 preferably includes three terminals 51, 52, and 53, respectively shown in FIGS. 5A to 5C, which are combined as shown in FIG. 6. More specifically, each terminal portion 50 includes a first terminal 51 connected to the sensor element 10, a second terminal 52 which is pressed into a throughhole 42 of the sealing member 40, and a third terminal 53 which is connected to a lead 60, which are bonded, for example, by welding (e.g., resistance welding) as shown in FIG. 6.

Among the three terminals 51, 52, and 53 of each terminal portion 50, the second terminal 52 is substantially columnar and has an outer diameter which is slightly larger than that of each throughhole 42 of the sealing member 40. By pressing the terminal portion 50 having such a second terminal 52 into a throughhole 42, the throughhole 42 is substantially completely closed. Moreover, as a result of this pressing-in, the outer diameter of the sealing member 40 also becomes slightly larger than its original outer diameter. In other words, the sealing member 40 becomes press-fitted in the cylindrical member 30. As a result, substantially complete closing also occurs between the cylindrical member 30 and the sealing member 40.

In the oxygen sensor 100 of the present preferred embodiment, as has been described above, the terminal portions 50 are press-fitted in the throughholes 42 of the sealing member 40, thus sealing the cylindrical member 30 and forming a watertight structure. Therefore, the sealing member 40 does not need to be a rubber member as is disclosed in Japanese Patent No. 3493875, and a heat-resistant resin can be used as the material of the sealing member 40. As a result, it is possible to suppress deterioration in waterproofness due to deterioration of the sealing member 40 due to heat. Moreover, since it is unnecessary to make the cylindrical member 30 long in order to prevent deterioration of the sealing member 40 due to heat, the oxygen sensor 100 itself can be downsized. Furthermore, since the throughholes 42 of the sealing member 40 are closed by the press-fitted terminal portions 50, even if the insulation material (resin such as PTFE) with which the leads 60 are coated shrinks due to heat, intrusion of water inside the oxygen sensor 100 can be prevented.

Although the present preferred embodiment illustrates each terminal portion 50 as including three terminals 51, 52, and 53, the structure of the terminal portions 50 is not limited thereto. It suffices if each terminal portion 50 includes a portion with a slightly larger outer diameter than that of each throughhole 42 of the sealing member 40, and each terminal portion 50 may be formed as one piece, two pieces, or four or more pieces.

For the heat-resistant resin as the material of the sealing member 40, a thermoplastic resin such as polyimide resin may be used, or a thermosetting resin such as phenolic resin may be used. Generally speaking, glass transition temperature is used as a parameter indicating the heat resistance of a thermoplastic resin, whereas heat deflection temperature is used as a parameter indicating the heat resistance of a thermosetting resin. From the standpoint of preventing deterioration of the sealing member 40 due to heat, the heat-resistant resin which is the material of the sealing member 40 preferably has a glass transition temperature or heat deflection temperature of 250° C. or more, and more preferably has a glass transition temperature or heat deflection temperature of 280° C. or more.

Moreover, by inserting the leads 60 into the throughholes 42 together with the watertight cap 80 as in the present preferred embodiment, it becomes possible to prevent intrusion of water and dust with greater certainty.

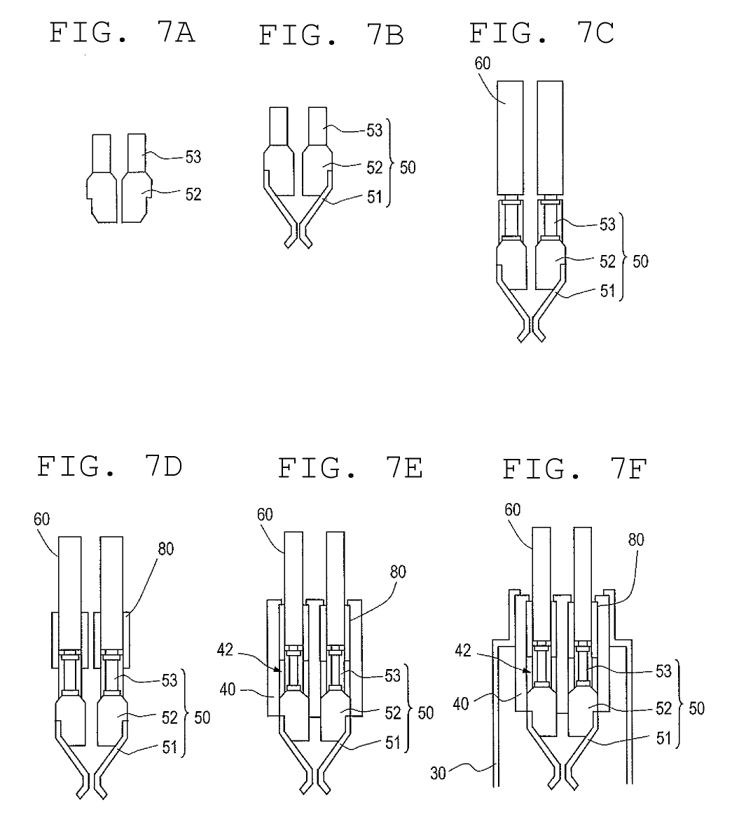

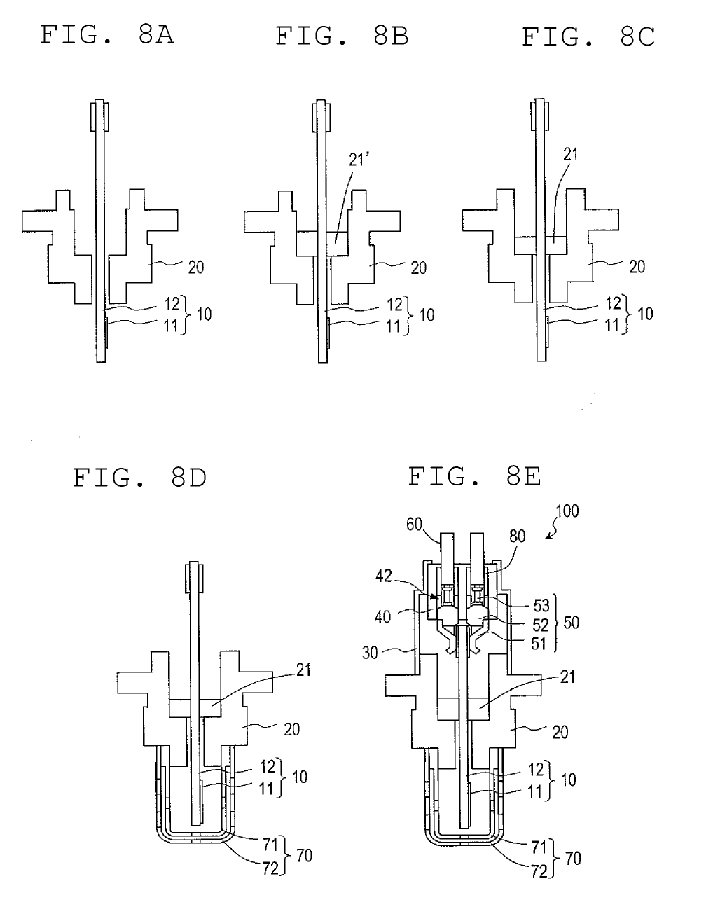

Next, an example of a method of producing the oxygen sensor 100 will be described with reference to FIGS. 7A-7F and FIGS. 8A-8E. FIGS. 7A-7F and FIGS. 8A-8E are step-by-step cross-sectional views schematically showing production steps for the oxygen sensor 100.

First, as shown in FIG. 7A, the third terminal 53 is bonded to the second terminal 52 preferably by welding (e.g., resistance welding). Next, as shown in FIG. 7B, the first terminal 51 is bonded to the second terminal 52 preferably by welding (e.g., resistance welding), thus forming a terminal portion 50.

Then, as shown in FIG. 7C, the third terminal 53 is crimped in order to connect the lead 60 and the terminal portion 50. Thereafter, as shown in FIG. 7D, a watertight cap 80 is attached to the leads 60.

Next, as shown in FIG. 7E, the terminal portion 50 is press-fitted in the throughhole 42 of the sealing member 40. The press-fit margin (dimensional difference at assembly) at this time is appropriately designed so that closure of the throughhole 42 by the terminal portion 50 will occur suitably. In other words, the outer diameter of the second terminal 52 of the terminal portion 50 is prescribed so that the press-fit margin is appropriate. The press-fit margin is preferably about 0.1 mm, for example.

Thereafter, as shown in FIG. 7F, the sealing member 40 is press-fitted in the cylindrical member 30. The press-fit margin at this time is appropriately designed so that closure of the cylindrical member 30 by the sealing member 40 will occur suitably. In other words, the outer diameter of the sealing member 40 is prescribed so that the press-fit margin is appropriate. The press-fit margin is preferably about 0.1 mm, for example.

Apart from producing an assembly containing the leads 60 (hereinafter simply referred to as the “lead assembly”) in the above-described manner, an assembly containing the sensor element 10 (hereinafter simply referred to as a “sensor element assembly”) is produced as follows.

First, as shown in FIG. 8A, the sensor element 10 including the detection section 11 and the substrate 12 is inserted into the housing 20. At this time, the sensor element 10 is disposed so that the detection section 11 is exposed at one end of the housing 20.

Next, as shown in FIG. 8B, a glass material 21′ is filled into the housing 20, and thereafter as shown in FIG. 8C, the glass material 21′ is solidified to form an attachment member 21, therebetween securing the sensor element 10 to the housing 20.

Then, as shown in FIG. 8D, a cover member 70 including the inner cover 71 and the outer cover 72 is attached to the housing 20. This attachment is performed by welding, for example. In this manner, the sensor element assembly is completed.

Thereafter, as shown in FIG. 8E, the lead assembly is attached to the sensor element assembly. At this time, an end of the sensor element 10 (opposite end from where the detection section 11 is provided) is inserted between the first terminals 51 of the two terminal portions 50, and the first terminals 51 and the sensor element 10 are connected. Moreover, the housing 20 of the sensor element assembly and the cylindrical member 30 of the lead assembly are bonded preferably by, e.g., welding (such as laser welding), in order to ensure watertightness. In this manner, the oxygen sensor 100 is completed.

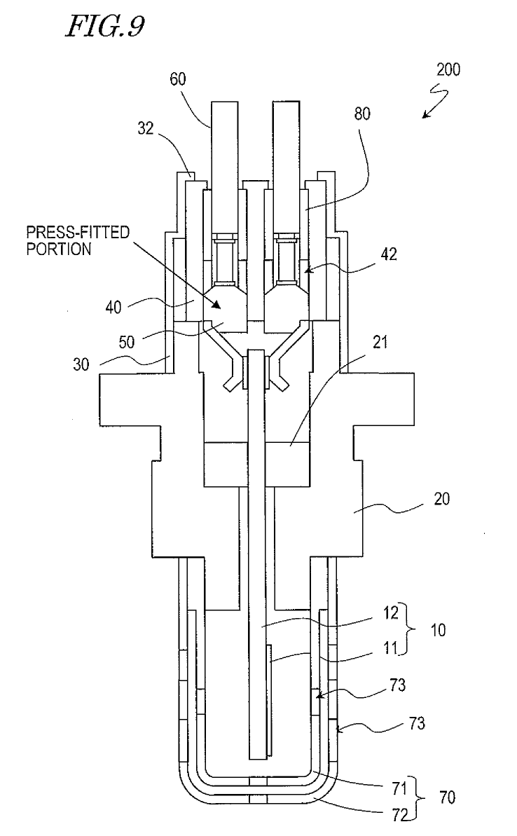

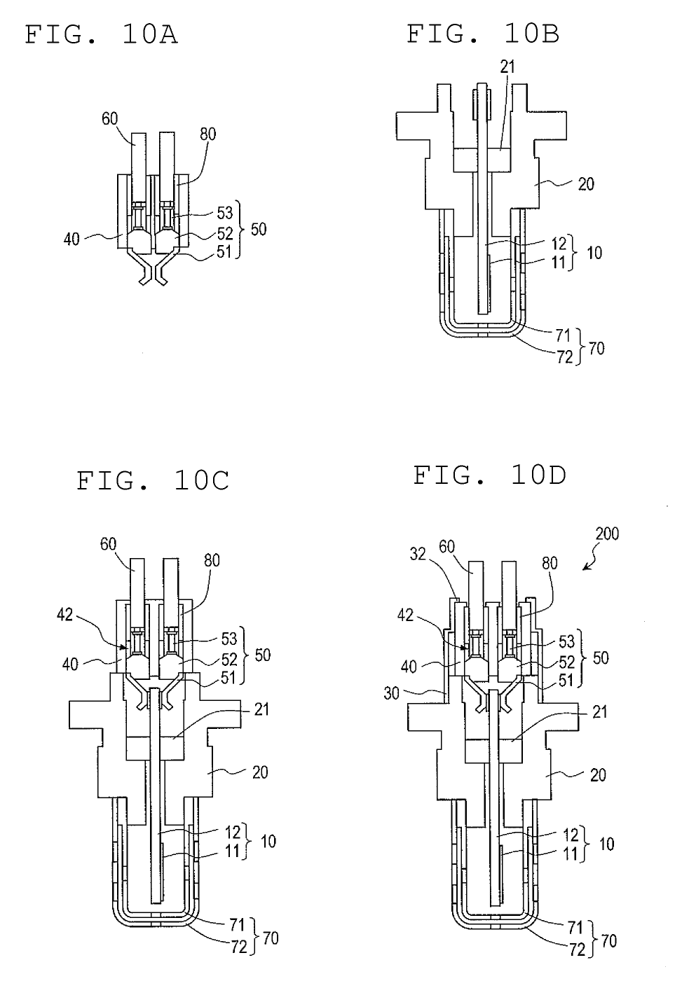

Then, other oxygen sensors according to other present preferred embodiments will be described. FIG. 9 shows another oxygen sensor 200 according to another preferred embodiment.

From the oxygen sensor 100 shown in FIG. 1, in which the housing 20 and the sealing member 40 are located spaced away from each other, the oxygen sensor 200 shown in FIG. 9 is distinct in that the housing 20 and the sealing member 40 abut each other (i.e., they are in contact where they meet).

The oxygen sensor 200 is produced as follows, for example.

First, as shown in FIG. 10A, a lead assembly is provided in which the terminal portions 50 being connected to the leads 60 are press-fitted in the throughholes 42 of the sealing member 40. This lead assembly can be produced in a manner similar to that which was described with reference to FIGS. 7A to 7E, but, unlike the lead assembly shown in FIG. 7F, does not include the cylindrical member 30.

Next, as shown in FIG. 10B, a sensor element assembly is provided in which the sensor element 10 is inserted into the housing 20 and the cover member 70 is attached to the housing 20. This sensor element assembly can be produced in a manner similar to that which was described with reference to FIGS. 8A to 8D.

Then, as shown in FIG. 10C, the lead assembly is attached to the sensor element assembly, and thereafter as shown in FIG. 10D, the sealing member 40 is press-fitted to the cylindrical member 30. In this manner, the oxygen sensor 200 is completed.

In the oxygen sensor 100 shown in FIG. 1, when attaching the lead assembly to the sensor element assembly (the step shown in FIG. 8E), the cylindrical member 30 of the lead assembly abuts the housing 20 of the sensor element assembly, so that the cylindrical member 30 and the housing 20 function as a positioning structure.

On the other hand, in the oxygen sensor 200 shown in FIG. 9, when attaching the lead assembly to the sensor element assembly (the step shown in FIG. 10C), the sealing member 40 of the lead assembly abuts the housing 20 of the sensor element assembly, so that the sealing member 40 and the housing 20 function as a positioning structure.

Thus, since the lead assembly can be attached to the sensor element assembly without the cylindrical member 30 (see FIG. 10C), the terminal portions 50 can be attached to the sensor element 10 under eyesight. Therefore, it is easy to achieve connection between the terminal portions 50 and the sensor element 10 (e.g. as performed by inserting the sensor element 10 between the first terminals 51), thereby resulting in a greater ease of assembly.

Moreover, the cylindrical member 30 shown in FIG. 9 includes a stopper portion 32 for stopping the sealing member 40 at the farther end from the housing 20. The stopper portion 32 is arranged so as to protrude inwards along the radial direction of the cylindrical member 30 (e.g., about 1 mm). By providing such a stopper portion 32, it becomes possible to firmly secure the sealing member 40 using the stopper portion 32 and the housing (i.e., a housing that abuts the sealing member 40) 20.

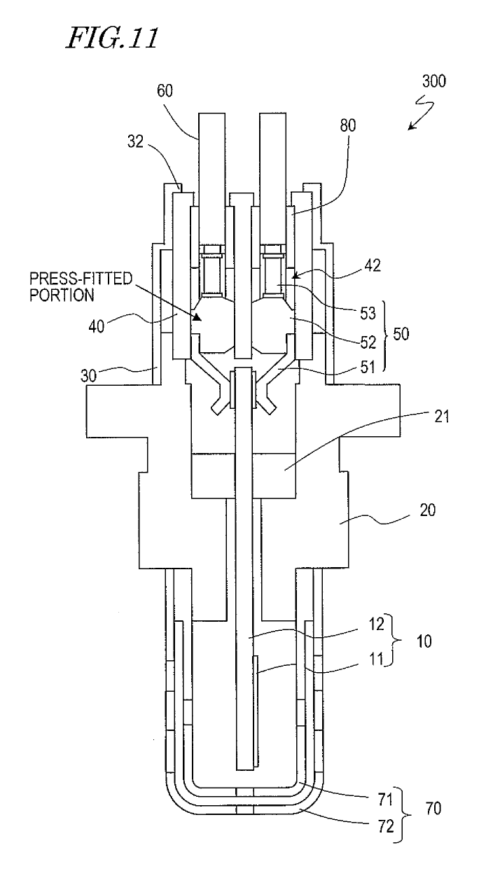

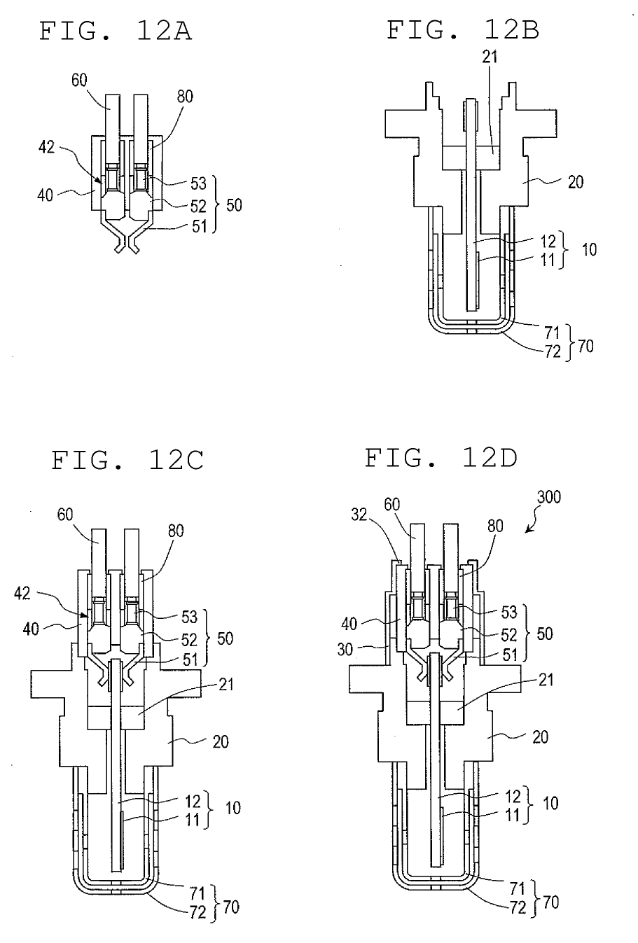

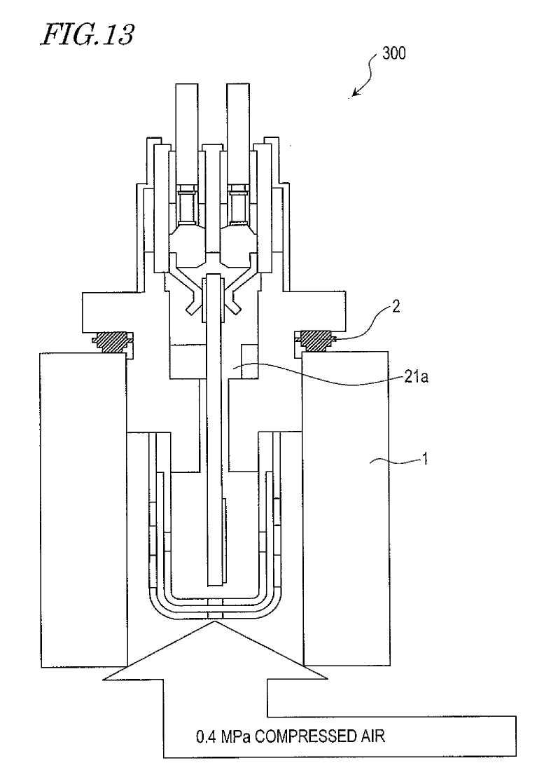

FIG. 11 shows still another oxygen sensor 300 according to the present preferred embodiment.

The oxygen sensor 300 shown in FIG. 11 is similar to the oxygen sensor 200 shown in FIG. 9 in that the housing 20 and the sealing member 40 abut each other, but differs therefrom in that the housing 20 and the sealing member 40 are shaped so as to be fitted together.

The oxygen sensor 300 is produced as follows, for example.

First, as shown in FIG. 12A, a lead assembly is provided in which the terminal portions 50 being connected to the leads 60 are press-fitted in the throughholes 42 of the sealing member 40. This lead assembly can be produced in a manner similar to that which was described with reference to FIGS. 7A to 7E.

Next, as shown in FIG. 12B, a sensor element assembly is provided in which the sensor element 10 is inserted in the housing 20 and the cover member 70 is attached to the housing 20. This sensor element assembly can be produced in a manner similar to that which was described with reference to FIGS. 8A to 8D.

Then, as shown in FIG. 12C, the lead assembly is attached to the sensor element assembly, and thereafter as shown in FIG. 12D, the sealing member 40 is press-fitted to the cylindrical member 30. In this manner, the oxygen sensor 300 is completed.

In the oxygen sensor 300 shown in FIG. 11, the housing 20 and the sealing member 40 are shaped so as to be fitted together. Therefore, in the step of press-fitting the sealing member 40 to the cylindrical member 30 (the step shown in FIG. 12D), movement of the sealing member 40 along the horizontal direction (the direction orthogonal to the center axis of the oxygen sensor 300) can be limited. Therefore, the stress acting on the foot of the sensor element 10 can be reduced, and occurrence of product defects due to breakage of the sensor element 10 can be suppressed.

Now, results of actually prototyping the oxygen sensor 300 of the present preferred embodiment and the conventional oxygen sensor 800 shown in FIG. 16, and evaluating their waterproofness in an airtightness test, will be described. As shown in FIG. 13, the airtightness test was performed by, with the oxygen sensor 300 being set on an air introducing jig 1, introducing 0.4 MPa compressed air into the housing 20 from an end where the detection section 11 of the oxygen sensor 300 is situated, and observing presence/absence of air leakage (air leakage from the airtight structure constituted by the sealing member 40) under water. Throughholes 21a for air introduction are formed in the attachment member 21 within the housing 20. Airtightness between the oxygen sensor 300 and the air introducing jig 1 is ensured by providing an O ring 2 between the air introducing jig 1 and the housing 20.

Table 1 shows results of the airtightness test with respect to the oxygen sensor 300 of the present preferred embodiment (Example) and the conventional oxygen sensor 800 (Comparative Example), after being left at 250° C. for a certain period of time. In Table 1, “O” means absence of air leakage, and “X” means presence of air leakage. Table 2 shows the specifications of the cylindrical member, leads, and the sealing member with respect to each of the Example and the Comparative Example.

TABLE 1

| | | time of being left at 250° C. (h) | | | | | | | | | |
|---|---|---|---|---|---|---|---|---|---|---|---|
| | No. | 0 | 2 | 4 | 6 | 8 | 10 | 24 | 48 | 75 | 100 |
| Example | 1 | ◯ | ◯ | ◯ | ◯ | ◯ | ◯ | ◯ | ◯ | ◯ | ◯ |
| | 2 | ◯ | ◯ | ◯ | ◯ | ◯ | ◯ | ◯ | ◯ | ◯ | ◯ |
| | 3 | ◯ | ◯ | ◯ | ◯ | ◯ | ◯ | ◯ | ◯ | ◯ | ◯ |
| Comparative | 1 | ◯ | ◯ | ◯ | ◯ | ◯ | ◯ | X | X | X | X |
| Example | 2 | ◯ | ◯ | ◯ | ◯ | ◯ | ◯ | X | X | X | X |
| | 3 | ◯ | ◯ | ◯ | ◯ | ◯ | X | X | X | X | X |

TABLE 2

| | Example | Comparative Example |
|---|---|---|
| cylindrical | outer diameter Φ10 mm, plate thickness 0.5 mm | |
| member | | |
| lead | outer diameter Φ1.65 mm | |
| sealing | heat-resistant resin, | fluoro rubber (hardness |
| member | outer diameter Φ9.1 mm, | 80Hs), |
| | throughhole diameter | outer diameter Φ9.0 mm, |
| | Φ1.65 mm, | throughhole diameter |
| | hole pitch diameter Φ5.2 mm | Φ1.7 mm, |
| | | hole pitch diameter Φ5.2 mm |

As can be seen from Table 1, the Comparative Example experienced an air leakage after being left at a high temperature for a long time. On the other hand, the Example did not experience an air leakage even after being left at a high temperature for a long time. Thus, it was proven that the oxygen sensor according to the present invention has good waterproofness in a high-temperature environment.

The oxygen sensors 100, 200, and 300 according to the present preferred embodiment are highly waterproof in a high-temperature environment, and therefore are suitably used for the detection of oxygen within the exhaust gas which is emitted from an internal combustion engine. The oxygen sensors 100, 200, and 300 according to the present preferred embodiment can be downsized (having good space economy), and therefore the space required for attachment to an exhaust pipe can be reduced. Therefore, the entire internal combustion engine can be downsized.

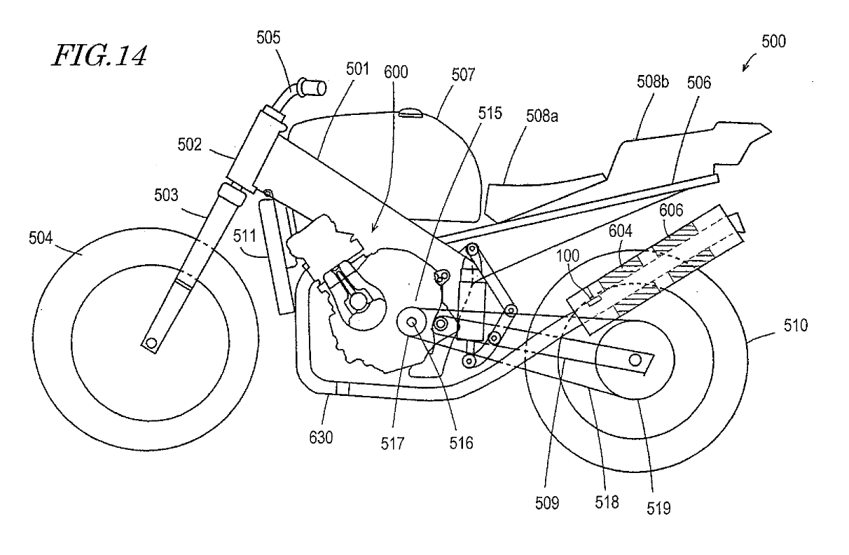

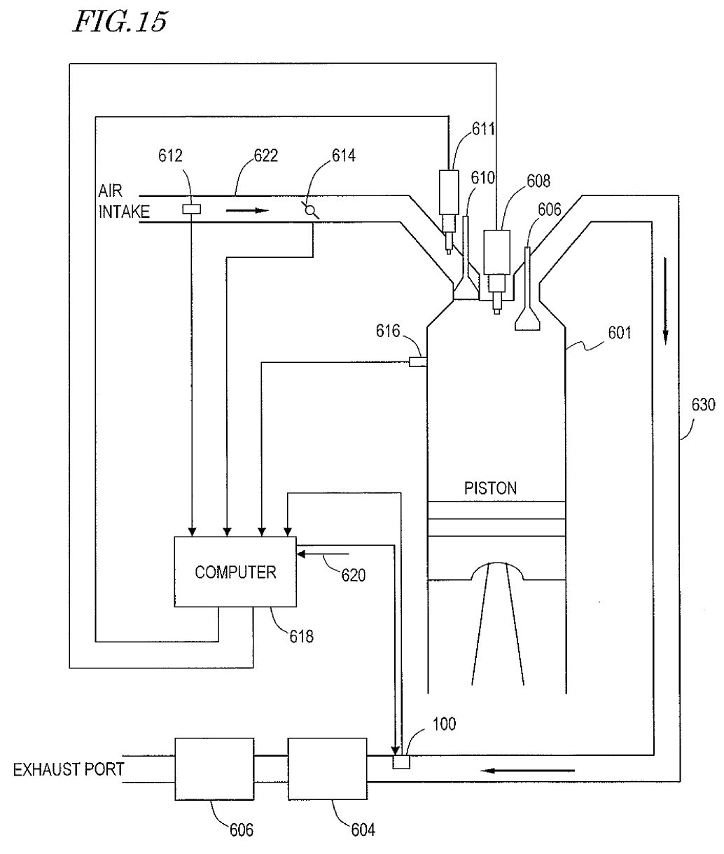

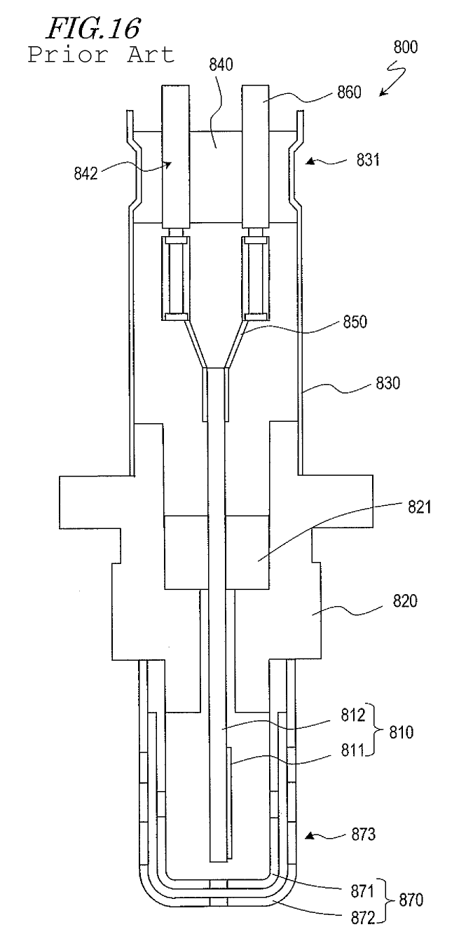

FIG. 14 schematically shows a motorcycle 500 incorporating the oxygen sensor 100 according to another preferred embodiment of the present invention. The motorcycle 500 includes a body frame 501 and an internal combustion engine 600. A head pipe 502 is provided at the front end of the body frame 501. To the head pipe 502, a front fork 503 is attached so as to be capable of swinging in the right-left direction. At the lower end of the front fork 503, a front wheel 504 is supported so as to be capable of rotating. Handle bars 505 are attached to the upper end of the head pipe 502.

A seat rail 506 is attached at an upper portion of the rear end of the body frame 501 so as to extend in the rear direction. A fuel tank 507 is provided above the body frame 501, and a main seat 508a and a tandem seat 508b are provided on the seat rail 506. Moreover, rear arms 509 extending in the rear direction are attached to the rear end of the body frame 501. At the rear end of the rear arms 509, a rear wheel 510 is supported so as to be capable of rotating.

The internal combustion engine 600 is held at the central portion of the body frame 501. A radiator 511 is provided in front of the internal combustion engine 600. An exhaust pipe 630 is connected to an exhaust port of the internal combustion engine 600. An oxygen sensor 100, a ternary-type catalyst 604, and a muffler 606 are provided on the exhaust pipe 630. The oxygen sensor 100 detects oxygen within the exhaust gas flowing in the exhaust pipe 630.

A transmission 515 is linked to the internal combustion engine 600. Driving sprockets 517 are attached on an output axis 516 of the transmission 515. Via a chain 518, the driving sprockets 517 are linked to rear wheel sprockets 519 of the rear wheel 510.

FIG. 15 shows main component elements of a control system of the internal combustion engine 600. On a cylinder 601 of the internal combustion engine 600, an intake valve 610, an exhaust valve 606, and a spark plug 608 are provided. There is also provided a water temperature sensor 616 for measuring the water temperature of the cooling water with which to cool the engine. The intake valve 610 is connected to an intake manifold 622, which has an air intake. On the intake manifold 622, an airflow meter 612, a throttle sensor 614 of a throttle valve, and a fuel injector 611 are provided.

The airflow meter 612, the throttle sensor 614, the fuel injector 611, the water temperature sensor 616, the spark plug 608, and the oxygen sensor 100 are connected to a computer 618, which is a control section. A vehicle velocity signal 620, which represents the velocity of the motorcycle 500, is also input to the computer 618.

When a rider starts the internal combustion engine 600 by using a self-starting motor (not shown), the computer 618 calculates an optimum fuel amount based on detection signals and the vehicle velocity signal 620 obtained from the airflow meter 612, the throttle sensor 614, and the water temperature sensor 616, and based on the result of calculation, outputs a control signal to the fuel injector 611. The fuel which is injected from the fuel injector 611 is mixed with the air which is supplied from the intake manifold 622, and injected into the cylinder 601 via the intake valve 610, which is opened or closed with appropriate timing. The fuel which is injected in the cylinder 601 combusts to become exhaust gas, which is led to the exhaust pipe 630 via the exhaust valve 606.

The oxygen sensor 100 detects the oxygen in the exhaust gas, and outputs a detection signal to the computer 618. Based on the signal from the oxygen sensor 100, the computer 618 determines the amount of deviation of the air-fuel ratio from an ideal air-fuel ratio. Then, the amount of fuel which is injected from the fuel injector 611 is controlled so as to attain the ideal air-fuel ratio relative to the air amount which is known from the signals obtained from the flow meter 612 and the throttle sensor 614. Thus, an air-fuel ratio controller which includes the oxygen sensor 100 and the computer (control section) 618 connected to the oxygen sensor 100 appropriately controls the air-fuel ratio of the internal combustion engine.

In the motorcycle 500 of the present preferred embodiment, the oxygen sensor 100 is highly waterproof, and therefore the oxygen sensor 100 can be properly operated even in an environment where wetting is predictable. Therefore, even in such an environment, fuel and air can be mixed at an appropriate air-fuel ratio; fuel can be combusted under an optimum condition; and the concentration of NOx and other regulated substances within the exhaust gas can be reduced. Moreover, since the oxygen sensor 100 has good space economy, it can be attached even if the space around the exhaust pipe 630 is small.

Although the present preferred embodiment has illustrated a motorcycle, for instance, the oxygen sensor according to various preferred embodiments of the present invention can also be used for any other transportation apparatus, e.g., a four-wheeled automobile. However, in a motorcycle, the distance from the end of the exhaust pipe to the position where the oxygen sensor is attached is short, and droplets of water are likely to attach to the oxygen sensor. Therefore, the oxygen sensor according to various preferred embodiments of the present invention is particularly suitably used for a motorcycle. Moreover, the internal combustion engine is not limited to a gasoline engine, but may alternatively be a diesel engine.

The gas sensor according to various preferred embodiments of the present invention is highly waterproof in a high-temperature environment and permits downsizing, and therefore can be suitably used for an internal combustion engine of various transportation apparatuses, e.g., a car, a bus, a truck, a motorbike, a tractor, an airplane, a motorboat, a vehicle for civil engineering use, or the like.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-8. (canceled)

9. An oxygen sensor comprising:
a sensor element having a detection section arranged to detect oxygen;
a housing, the sensor element being inserted at one end thereof in such a manner that the detection section is exposed;
a cylindrical member provided at another end of the housing;
a sealing member arranged to seal the cylindrical member; and
a terminal portion connected to the sensor element; wherein
the sealing member has a throughhole, and is made of a heat-resistant resin; and
the terminal portion is press-fitted in the throughhole of the sealing member.

10. The oxygen sensor of claim 9, wherein the housing and the sealing member abut each other.

11. The oxygen sensor of claim 10, wherein the housing and the sealing member are shaped so as to be fitted together.

12. The oxygen sensor of claim 9, wherein the heat-resistant resin has a glass transition temperature or heat deflection temperature of about 250° C. or more.

13. The oxygen sensor of claim 9, further comprising a lead which is electrically connected to the sensor element via the terminal portion, wherein the lead is inserted in the throughhole of the sealing member.

14. The oxygen sensor of claim 13, further comprising a watertight cap covering the lead, wherein the lead is inserted in the throughhole together with the watertight cap.

15. An internal combustion engine comprising the oxygen sensor of claim 9.

16. A transportation apparatus comprising the internal combustion engine of claim 15.
